(19) United States
(12) Patent Application Publication
(10) Pub. No.: US 2016/0217246 A1
(43) Pub. Date: Jul. 28, 2016

(54) TEST METHOD, APPARATUS AND NON-TRANSITORY COMPUTER-READABLE RECORDING MEDIUM STORING TEST PROGRAM

(71) Applicant: Socionext Inc., Yokohama-shi (JP)

(72) Inventor: Tomio SATO, Atsugi (JP)

(73) Assignee: Socionext Inc., Yokohama-shi (JP)

(21) Appl. No.: 14/994,416

(22) Filed: Jan. 13, 2016

(30) Foreign Application Priority Data
Jan. 26, 2015 (JP) 2015-012305

(51) Int. Cl. G06F 17/50

(52) U.S. Cl. CPC G06F 17/5081; G06F 17/5009

(57) ABSTRACT

In a test apparatus, a processor determines an area in a circuit area of a semiconductor device indicated by design data, on the basis of attenuation characteristics of a pulse signal caused by electrostatic discharge. The attenuation characteristics of the pulse signal are dependent on a frequency of the pulse signal and a distance from an input point of the pulse signal. The processor extracts a resistor, a capacitor, or an inductor from the determined area, and creates an equivalent circuit of the semiconductor device within the area on the basis of a result of the extraction.

### CROSS-REFERENCE TO RELATED APPLICATION

This application is based upon and claims the benefit of priority of the prior Japanese Patent Application No. 2015-012305, filed on Jan. 26, 2015, the entire contents of which are incorporated herein by reference.

### FIELD

The embodiments discussed herein relate to a test method, a test apparatus and a non-transitory computer-readable recording medium storing a test program.

### BACKGROUND

When an electrostatically-charged human body or machine comes into contact with an input-output pin of a semiconductor device, electrostatic discharge (ESD) occurs. This ESD could cause damage to elements, wirings, etc. in the semiconductor device. To address this problem, when designing a semiconductor device, a manufacturer performs an ESD test for testing an impact of electrostatic discharge on the semiconductor device.

When performing an ESD test on a semiconductor device, for example, a manufacturer uses ESD test models referred to as a human body model (HEM), a machine model (MM), and a charged device model (CDM). The manufacturer creates equivalent circuits of the semiconductor device for the respective ESD test models. For example, in an equivalent circuit, external terminals, power supply wirings, ESD protection elements, etc. are modeled by resistors or the like, and a current caused by ESD is input to an external terminal in the equivalent circuit, to determine whether a voltage exceeding the withstand level of an element occurs.

See, for example, the following documents:

Japanese Laid-open Patent Publication No. 2014-13482

Japanese Laid-open Patent Publication No. 2013-69143

Japanese Laid-open Patent Publication No. 2008-15898

However, when a manufacturer tests an impact of a relatively high frequency ESD signal on a semiconductor device by using a CDM, the manufacturer creates an equivalent circuit by extracting a capacitive component and an inductive component from design data of the semiconductor device, in addition to a resistive component. The manufacturer extracts these components with finer granularity, compared with a test in which the manufacturer tests an impact of a relatively low frequency ESD signal by using an HEM. As a result, there are problems that the size of the equivalent circuit is increased and that the amount of calculation for the test is increased.

### SUMMARY

According to one aspect, there is provided a test method for testing an impact of electrostatic discharge on a semiconductor device. The method includes: determining, by a processor, a first area in a circuit area of the semiconductor device indicated by design data, based on attenuation characteristics of a pulse signal caused by the electrostatic discharge, the attenuation characteristics of the pulse signal being dependent on a frequency of the pulse signal and a distance from an input point of the pulse signal; extracting, by the processor, a resistor, a capacitor, or an inductor, or any combination thereof from the determined first area; and creating, by the processor, an equivalent circuit of the semiconductor device within the first area, based on a result of the extracting.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a test method according to a first embodiment;

FIG. 2 is a block diagram illustrating functions of an example of a test apparatus according to the first embodiment;

FIG. 3 illustrates an example of a test apparatus according to a second embodiment;

FIG. 4 is a flowchart illustrating processing of an example of a test method according to the second embodiment;

FIG. 5 is a flowchart illustrating an example of extraction area determination processing;

FIG. 6 illustrates an example of an attenuation rate table;

FIG. 7 illustrates an example of a netlist;

FIG. 8 illustrates an example in which an attenuation rate table is created by calculation;

FIG. 9 illustrates an example in which an attenuation rate table is created by measurement;

FIG. 10 illustrates an example of a set of attenuation rates obtained by measurement;

FIG. 11 illustrates an example of a set of attenuation rates obtained by calculation;

FIG. 12 is a flowchart illustrating an example of creating an attenuation rate table by calculation; and

FIG. 13 is a flowchart illustrating an example of creating an attenuation rate table by performing interpolation processing on measured values.

### DESCRIPTION OF EMBODIMENTS

Several embodiments will be described below with reference to the accompanying drawings, wherein like reference numerals refer to like elements throughout.

### First Embodiment

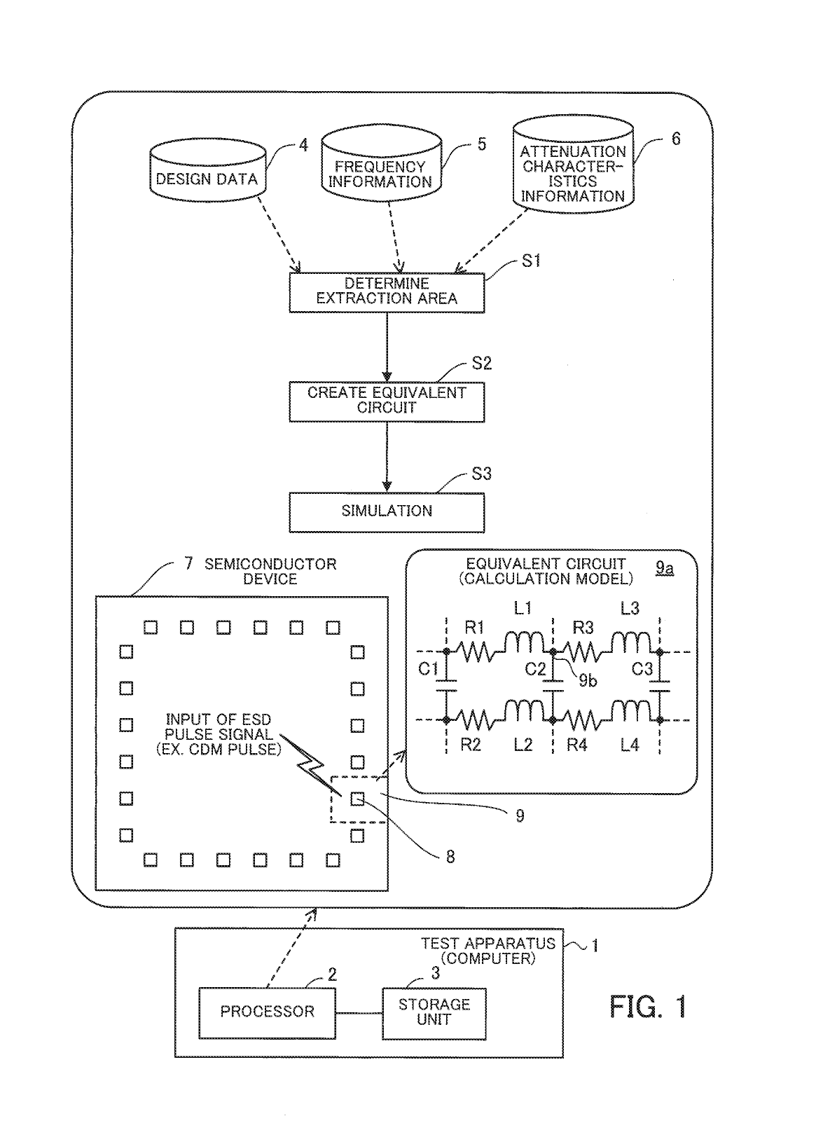

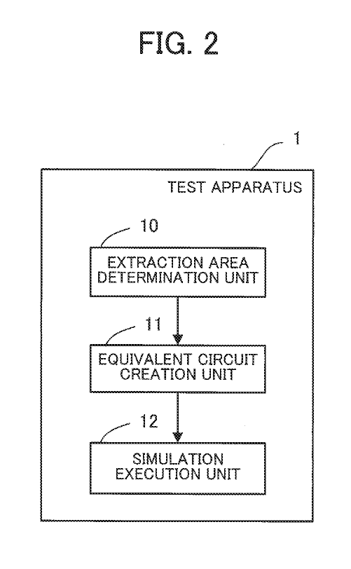

FIG. 1 illustrates an example of a test method according to a first embodiment. FIG. 2 is a block diagram illustrating functions of an example of a test apparatus according to the first embodiment.

For example, a test apparatus 1 is a computer and includes a processor 2 and a storage unit 3. By using data and programs stored in the storage unit 3, the processor 2 realizes functions of an extraction area determination unit 10, an equivalent circuit creation unit 11, and a simulation execution unit 12, as illustrated in FIG. 2.

The storage unit 3 holds various types of data and programs executed by the processor 2. For example, the storage unit 3 holds design data 4, frequency information 5, and attenuation characteristics information 6.

The design data 4 includes layout data of a semiconductor device to be tested and information about external connection terminals and ESD protection elements. For example, these items of information are represented in Design Exchange Format (DEF).

The frequency information 5 includes information about frequencies of ESD pulse signals used in a simulation.

The attenuation characteristics information 6 includes information about attenuation characteristics of a pulse signal caused by ESD that are dependent on a frequency of the pulse signal and a distance from an input point of the pulse signal. The pulse signal attenuation characteristics will be described below.

Next, functions of functional blocks included in the test apparatus 1 in FIG. 2 will be described.

The extraction area determination unit 10 refers to the frequency information 5 and the attenuation rate information 6 and determines an area in a circuit area of the semiconductor device indicated by the design data 4.

The equivalent circuit creation unit 11 extracts a resistor, a capacitor, or an inductor from the area determined by the extraction area determination unit 10 and creates an equivalent circuit of the semiconductor device within the determined area.

The simulation execution unit 12 performs a simulation by using the equivalent circuit created by the equivalent circuit creation unit 11 and determines whether a voltage exceeding the withstand level of the semiconductor device is caused by ESD, for example.

Next, an example of the test method using the above test apparatus 1 will be described with reference to FIG. 1. Since, as described above, the processor 2 realizes the functions of the extraction area determination unit 10, the equivalent circuit creation unit 11, and the simulation execution unit 12 in FIG. 2, the following description will be made assuming that the processor 2 performs the following processing.

Step S1: The processor 2 reads the frequency information 5 and the attenuation rate information 6 held in the storage unit 3. The processor 2 determines an area in a circuit area of the semiconductor device indicated by the design data 4, based on attenuation characteristics of a pulse signal caused by ESD that are dependent on a distance from an input point of the pulse signal and a frequency of the pulse signal.

When a pulse signal caused by ESD propagates through a circuit area of a semiconductor device, the pulse signal attenuates as it propagates away from the input point thereof. In addition, a pulse signal having a higher frequency attenuates more easily. The attenuation of a pulse signal through a semiconductor device depends on electric characteristics of the semiconductor device. On the basis of the attenuation characteristics, the processor 2 excludes an area that is affected little by the pulse signal in the circuit area of the semiconductor device from the above parameter extraction area.

For example, the processor 2 obtains a distance between the input point and a point at which the current or voltage value of a pulse signal having a certain frequency is less than or equal to the allowable current or voltage value (withstand level) of the semiconductor device. Next, the processor 2 determines an area corresponding to the obtained distance to be the extraction area from which the processor 2 is to extract a resistor, a capacitor, or an inductor. The processor 2 excludes an area farther than the determined area from the extraction area.

FIG. 1 illustrates an example of a semiconductor device 7. For example, the semiconductor device 7 is a system-on-chip (SoC). In the example in FIG. 1, an input-output pad 8 in the semiconductor device 7 is an input point to which a pulse signal used in a CDM test (this signal will hereinafter be referred to as a CDM pulse) is input. In step S1, for example, the processor 2 determines an area 9 having the input-output pad 8 as the center to be an area from which the processor 2 is to extract a resistor, a capacitor, or an inductor.

Step S2: The processor 2 extracts a resistor, a capacitor, or an inductor from the area determined in step S1 and creates an equivalent circuit of the semiconductor device within the area. The value of the resistor, the capacitor, or the inductor is determined on the basis of process information (not illustrated). The process information includes information about sheet resistance of an individual wiring layer and information about a dielectric constant and thickness of an individual insulating layer of the semiconductor device.

FIG. 1 illustrates an example of an equivalent circuit 9a created by the processor 2.

FIG. 1 illustrates a part of the equivalent circuit 9a created for testing an impact of a relatively high frequency ESD signal with a CDM or the like. The equivalent circuit 9a includes capacitors C1 to C3, resistors R1 to R4, and inductors L1 to L4.

One end of the capacitor C1 is connected to one end of the resistor R1 and the other end of the capacitor C1 is connected to one end of the resistor R2. The other end of the resistor R1 is connected to one end of the inductor L1, and the other end of the resistor R2 is connected to one end of the inductor L2. The other end of the inductor L1 is connected to one end of the capacitor C2, and the other end of the inductor L2 is connected to the other end of the capacitor C2.

One end of the capacitor C2 is also connected to one end of the resistor R3, and the other end of the capacitor C2 is also connected to one end of the resistor R4. The other end of the resistor R3 is connected to one end of the inductor L3, and the other end of the resistor R4 is connected to one end of the inductor L4. The other end of the inductor L3 is connected to one end of the capacitor C3, and, the other end of the inductor L4 is connected to the other end of the capacitor C3.

Step S3: The processor 2 performs a simulation by using the equivalent circuit 9a. In step S3, when performing a circuit simulation, for example, the processor 2 inputs a CDM pulse to a node 9b in the equivalent circuit 9a. Next, the processor 2 determines whether the current or voltage of the input CDM pulse exceeds the withstand level of the semiconductor device 7 and outputs a test result.

According to the above test method and test apparatus, to create an equivalent circuit, which is a calculation model for an ESD test, the test apparatus determines a parameter extraction area from a circuit area of the semiconductor device 7, based on attenuation characteristics of an ESD pulse signal. As a result, the size of the calculation model is not increased, and therefore, the amount of calculation is reduced. In this way, even when the test apparatus creates an equivalent circuit (a circuit including capacitive and inductive components in addition to a resistive component) for testing the impact of a relatively high frequency ESD signal with a CDM, the test apparatus performs a simulation easily.

Since the equivalent circuit 9a in FIG. 1 is a calculation model for testing the impact of a relatively high frequency ESD signal with a CDM, the equivalent circuit 9a includes capacitors and inductors in addition to resistors. However, when testing the impact of a relatively low frequency ESD signal, the test apparatus may use an equivalent circuit that does not include capacitors and inductors.

### Second Embodiment

Hereinafter, a test method and a test apparatus according to a second embodiment will be described.

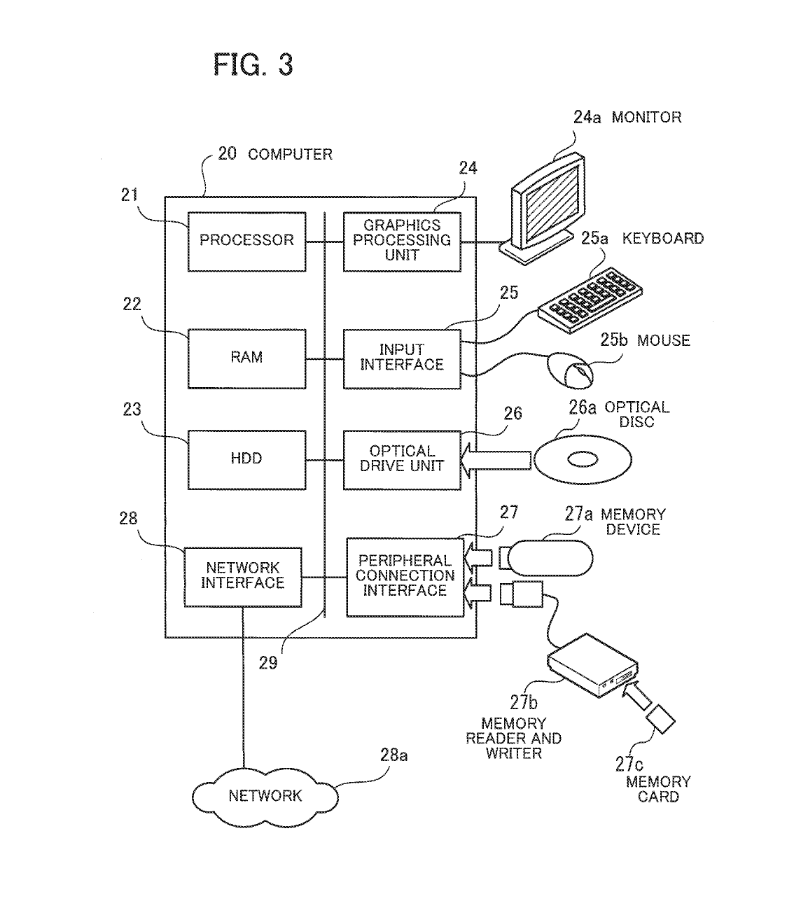

FIG. 3 illustrates an example of a test apparatus according to the second embodiment.

For example, the test apparatus is a computer 20, which is comprehensively controlled by a processor 21. A random access memory (RAM) 22 and a plurality of peripheral devices are connected to the processor 21 via a bus 29. The processor 21 may be a multiprocessor. For example, the processor 21 is a central processing unit (CPU), a micro processing unit (MPU), a digital signal processor (DSP), an application specific integrated circuit (ASIC), or a programmable logic device (PLD). The processor 21 may be a combination of at least two of the following elements: a CPU, an MPU, a DSP, an ASIC, and a PLD.

The RAM 22 is used as a main storage device of the computer 20. At least a part of an operating system (OS) program or an application program executed by the processor 21 is temporarily stored in the RAM 22. In addition, various types of data needed for processing by the processor 21 are stored in the RAM 22.

Examples of the peripheral devices connected to the bus 29 include a hard disk drive (HDD) 23, a graphics processing unit 24, an input interface 25, an optical drive unit 26, a peripheral connection interface 27, and a network interface 28.

The HDD 23 magnetically reads and writes data on a disk therein. The HDD 23 is used as an auxiliary storage device of the computer 20. OS programs, application programs, and various types of data are stored in the HDD) 23. A semiconductor storage device such as a flash memory may be used as the auxiliary storage device.

The graphics processing unit 24 is connected to a monitor 24a and displays an image on a screen of the monitor 24a in accordance with a command from the processor 21. For example, a display device using a cathode ray tube (ORT) or a liquid crystal display (LCD) device may be used as the monitor 24a.

The input interface 25 is connected to a keyboard 25a and a mouse 25b. The input interface 25 forwards signals transmitted from the keyboard 24a and the mouse 25b to the processor 21. The mouse 25b is an example of a pointing device. Namely, a different pointing device may be used. A touch panel, a tablet, a touch pad, a trackball, or the like may be used as the pointing device.

The optical drive unit 26 uses laser light or the like to read data recorded on an optical disc 26a. The optical disc 26a is a portable recording medium on which data readable by optical reflection is recorded. Examples of the optical disc 26a include a digital versatile disc (DVD), a DVD-RAM, a compact disc read-only memory (CD-ROM), and a CD recordable (CD-R)/rewritable (RW).

The peripheral connection interface 27 is a communication interface for connecting peripheral devices to the computer 20. For example, a memory device 27a and a memory reader and writer 27b may be connected to the peripheral connection interface 27. The memory device 27a is a recording medium capable of communicating with the peripheral connection interface 27. The memory reader and writer 27b is a device for reading and writing data on a memory card 27c. The memory card 27c is a card-type recording medium.

The network interface 28 is connected to a network 28a. The network interface 28 exchanges data with other computers or communication devices via the network 28a.

The processing functions according to the second embodiment are realized by using the hardware configuration as described above. In addition, the test apparatus 1 according to the first embodiment illustrated in FIG. 1 is also realized by using the same hardware configuration as that of the computer 20 illustrated in FIG. 3.

The computer 20 realizes the processing functions according to the second embodiment by executing a program recorded in a computer-readable recording medium, for example. The program executed by the computer 20 may be recorded in various types of recording media. For example, the program may be stored in the HDD 23. The processor 21 loads at least a part of the program stored in the HDD 23 onto the RAM 22 and executes the program. The program may be recorded in a portable recording medium such as the optical disc 26a, the memory device 27a, or the memory card. 27c. In this case, for example, the processor 21 may execute the program after installing it to the HDD 23. Alternatively, the processor 21 may execute the program by reading the program directly from the portable recording medium.

[An Example of the Test Method]

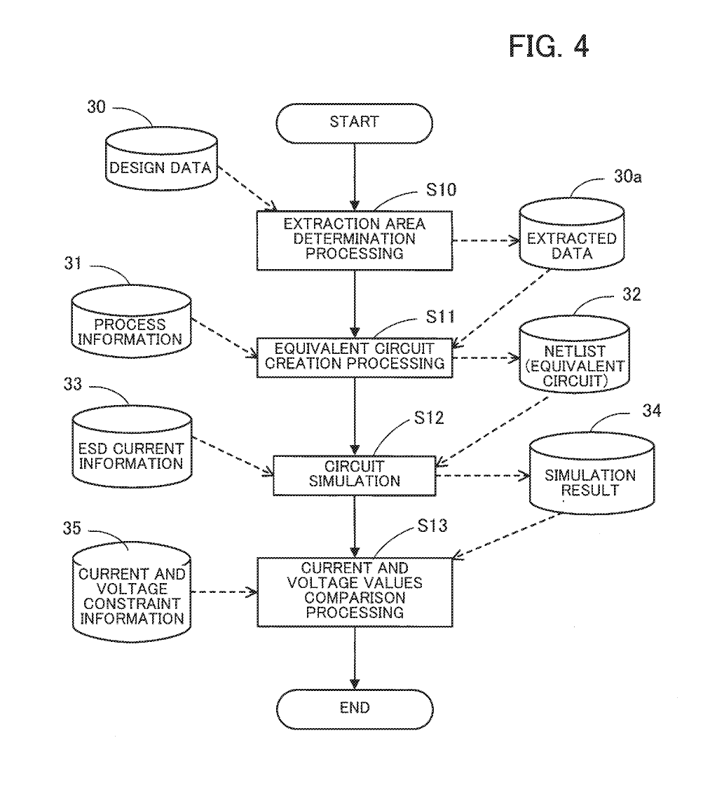

FIG. 4 is a flowchart illustrating processing of an example of a test method according to the second embodiment.

The processor 21 of the computer 20 reads a program stored in the HDD 23, expands the program on the RAM 22, and performs processing in each step illustrated in FIG. 4, for example.

Step S10: For example, the processor 21 reads design data 30 of a semiconductor device (for example, a SoC) stored in the HDD 23 and performs processing for determining an area from which the processor 21 is to extract a resistor, a capacitor, or an inductor.

The design data 30 includes layout data of a semiconductor device to be tested and information about external connection terminals and ESD protection elements.

For example, the processor 21 performs the processing in step S10 as described below.

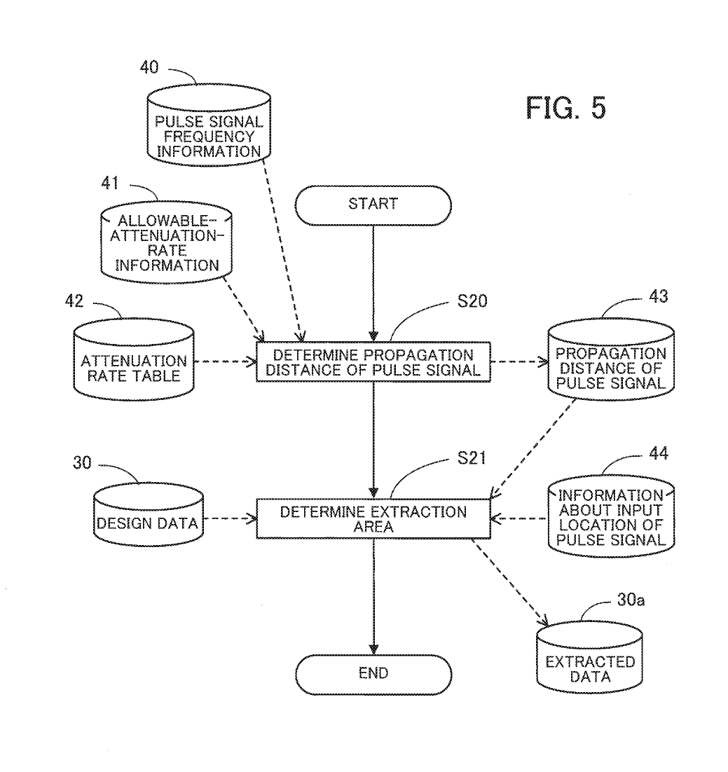

FIG. 5 is a flowchart illustrating an example of extraction area determination processing.

Step S20: The processor 21 reads pulse signal frequency information 40, allowable-attenuation-rate information 41, and attenuation rate table 42 that are stored in the HDD 23, for example. On the basis of the acquired information, the processor 21 determines a propagation distance 43 of an ESD pulse signal applied to the semiconductor device.

The pulse signal frequency information 40 includes information about frequencies of ESD pulse signals. For example, a current generated by a CDM pulse flows for about 1 ns. Therefore, the frequency of the CDM pulse is set to 1 GHz, for example.

For example, the allowable-attenuation-rate information 41 indicates an attenuation rate that corresponds to when the current or voltage value of a pulse signal having a certain frequency is less than or equal to the withstand level (the above allowable current or voltage value) of the semiconductor device (this attenuation rate will hereinafter be referred to as an allowable attenuation rate).

For example, the allowable attenuation rate is set on the basis of the ratio between the initial voltage of a pulse signal and the withstand voltage of a semiconductor device to be tested. For example, when the initial voltage of a pulse signal is 100 V and the withstand voltage of a semiconductor device to be tested is 1 V, the allowable attenuation rate is set to 0.01.

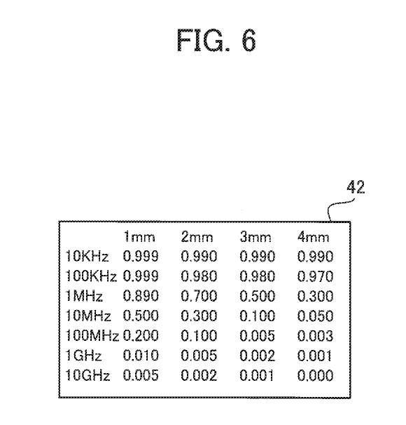

FIG. 6 illustrates an example of the attenuation rate table.

In the attenuation rate table 42 in FIG. 6, attenuation characteristics of pulse signals are represented by attenuation rates of 0.000 to 0.999. The attenuation rate of a pulse signal is dependent on a frequency of the pulse signal and a distance from an input point of the pulse signal. As seen from FIG. 6, a pulse signal having a higher frequency results in a smaller attenuation rate. Namely, a pulse signal having a higher frequency attenuates more easily. In addition, a longer distance from the input point of a pulse signal results in a smaller attenuation rate. Namely, the pulse signal attenuates more easily as the distance from the input point of the pulse signal is extended. Methods of creating the attenuation rate table 42 will be described below.

For example, a case in which the processor 21 tests an impact of a CDM pulse on a semiconductor device will be described. When the frequency of the CDM pulse is 1 GHz and the allowable attenuation rate is 0.001, the processor 21 determines the propagation distance to be 4 mm from the attenuation rate table 42 in FIG. 6.

Step S21: The processor 21 determines an area in the circuit area of the semiconductor device, based on the pulse signal propagation distance 43 determined in step S20 and input location information 44 of the pulse signal. Next, the processor 21 extracts the determined area from the design data 30 and generates extraction data 30a.

The input location information 44 of the pulse signal indicates the input point of the ESD) pulse signal. For example, the input location information 44 includes information about the coordinates of the external terminal of the semiconductor device to which an ESD pulse signal is input.

In step S21, from the design data 30, the processor 21 extracts an area that corresponds to the ESD pulse signal propagation distance 43. The area includes the input point of the ESD pulse signal as the center. The processor 21 may extract the area by using a graphics processing tool. In addition, when using the graphics processing tool, the processor 21 does not need to process the exact value of the pulse signal propagation distance 43. Namely, the processor 21 may round the value to a processing unit that can be processed by the graphics processing tool. In addition, if a plurality of pulse signal input points exist, the processor 21 performs the extraction processing multiple times to extract all the areas corresponding to the input points.

On the basis of the extraction data 30a generated in the above processing, the processor 21 performs step S11 in FIG. 4. The processor 21 may temporarily store the extraction data 30a in the HDD 23 or cause the graphics processing unit 24 to display the extraction data 30a on the monitor 24a.

Step S11: On the basis of the extraction data 30a and process information 31, the processor 21 creates, as an equivalent circuit of the semiconductor device, a netlist 32 including information about the resistor, the capacitor, or the inductor.

The process information 31 includes information about sheet resistance of an individual wiring layer and a dielectric constant and thickness of an individual insulating layer of the semiconductor device 7. The processor 21 determines the values of the resistor, the capacitor, and the inductor on the basis of the process information 31.

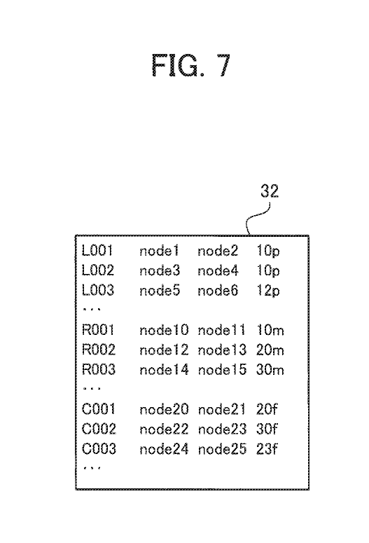

FIG. 7 illustrates an example of the netlist 32.

The netlist 32 in FIG. 7 illustrates names of nodes to which resistors, capacitors, and inductors are connected and values of the resistors, capacitors, and inductors.

“L001” to “L003,” “R001” to “R003,” and “C001” to “C003” are the names of the inductors, the resistors, and the capacitors, respectively. In addition, “node 1” to “node 25” are the names of the nodes. Values “10 p,” “10 m,” “20 f,” etc. represent the values of the inductors, the resistors, and the capacitors, respectively. The values “10 p,” “10 m,” and “20 f” indicate 10 pH, 10 mΩ, and 20 fF, respectively.

In addition, in the netlist 32, no elements are connected at the edge of the extraction data 30a. However, since the pulse signal attenuates to a sufficiently small level at the edge of the extraction data 30a, the test result is affected little.

The processor 21 may temporarily store the information in the netlist 32 in the HDD 23 before performing a circuit simulation or cause the graphics processing unit 24 to display the information in the netlist 32 on the monitor 24a. The processor 21 may cause the graphics processing device 24 to display the equivalent circuit 9a as illustrated in FIG. 1 on the monitor 24a.

Step S12: The processor 21 performs a circuit simulation on the basis of the netlist 32 and ESD current information 33.

In the ESD current information 33, the current waveform of the ESD pulse signal is modeled. By performing the circuit simulation on the basis of the netlist 32 and the ESD current information 33, the processor 21 generates a simulation result 34.

The simulation result 34 includes information about current and voltage waveforms.

Step S13: The processor 21 performs current and voltage values comparison processing on the basis of the simulation result 34 and current and voltage constraint information 35.

The current and voltage constraint information 35 includes information about the withstand voltage and current levels of the semiconductor device to be tested. The processor 21 compares information about the current and voltage waveforms included in the simulation result 34 with the current and voltage constraint information 35 and determines whether a voltage or current exceeding the withstand voltage or current level of the semiconductor device occurs. The processor 21 may cause the graphics processing unit 24 to display the comparison result on the monitor 24a, for example. In this case, the processor 21 may cause the graphics processing unit 24 to display a part where the voltage or current exceeding the withstand voltage or current level of the semiconductor device is occurring in red, for example.

According to the above test method, to create the netlist (equivalent circuit) 32 illustrated in FIG. 7, the test apparatus limits the element (a resistor, a capacitor, an inductor, etc.) extraction area in the circuit area of the semiconductor device to the area of the extraction data 30a extracted on the basis of the attenuation characteristics of the ESD pulse signal. In this way, the size of the equivalent circuit, which is a calculation model for a circuit simulation is not increased, and therefore, the amount of calculation is reduced.

Thus, even with an equivalent circuit for testing an impact of a relatively high frequency ESD signal with a CDM, the test apparatus performs a simulation easily. A typical CDM pulse propagates approximately 1 to 2 mm. When a CDM pulse propagation area is compared with the area of a SoC, the propagation area is smaller by approximately two digits. Thus, the created equivalent circuit is smaller by approximately two digits.

Next, examples of methods of creating the attenuation rate table 42 as illustrated in FIG. 6 will be described.

[Examples of Methods of Creating the Attenuation Rate Table]

First, an example in which the attenuation rate table 42 is created by calculation will be described. The processor 21 may create the attenuation rate table 42 by calculation by or another computer may create the attenuation rate table 42.

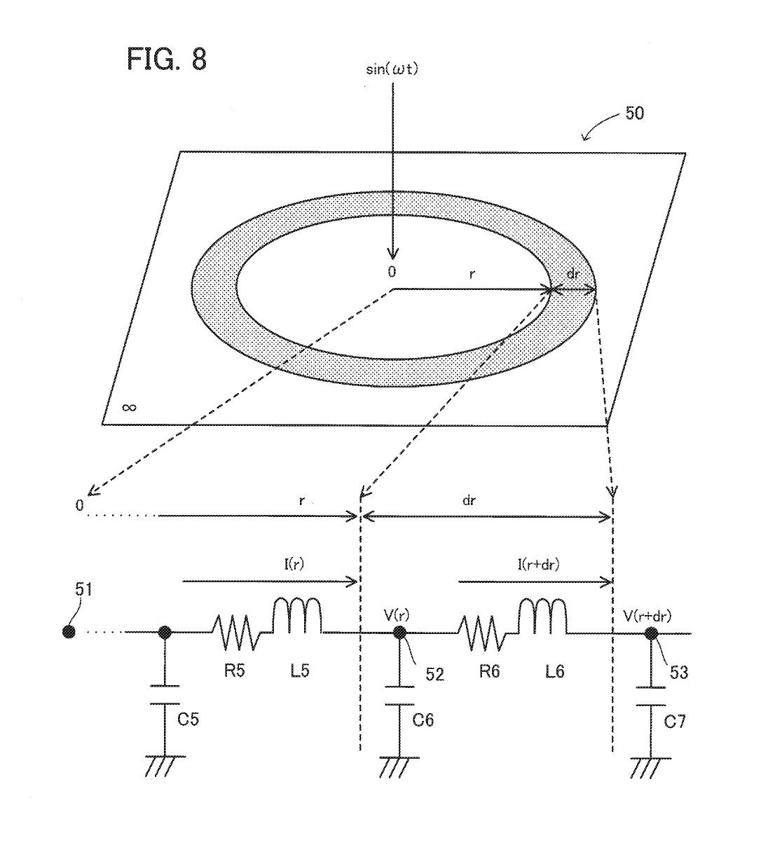

FIG. 8 illustrates an example in which the attenuation rate table is created by calculation.

The following calculation example assumes that a cylindrical coordinate system in which the center of a semiconductor device 50 to be tested is indicated as 0 is used and that the area (the chip area) of the semiconductor device 50 is infinite, as illustrated in FIG. 8.

In addition, the semiconductor device 50 is viewed as a circuit model in which resistors, capacitors, and inductors are repeatedly connected as illustrated in FIG. 8.

One end of a capacitor C5 is connected to one end of a resistor R5, and the other end of the capacitor C5 is grounded. One end of the resistor R5 is connected to one end of the capacitor C5, and the other end of the resistor R5 is connected to one end of an inductor L5. One end of the inductor L5 is connected to the other end of the resistor R5, and the other end of the inductor L5 is connected to one end of a capacitor C6. One end of the capacitor C6 is connected to one end of a resistor R6, and the other end of the capacitor C6 is grounded. One end of the resistor R6 is connected to one end of the capacitor C6, and the other end of the resistor R6 is connected to one end of an inductor L6. One end of the inductor L6 is connected to the other end of the resistor R6, and the other end of the inductor L6 is connected to one end of a capacitor C7. The other end of the capacitor C7 is grounded.

Hereinafter, in the circuit model, a node to which a sine-wave signal is input and which corresponds to the center of the semiconductor device 50 is represented as a node 51. In addition, a point at which one end of the capacitor C6, the other end of the inductor L5, and one end of the resistor R6 are connected is represented as a node 52. In addition, a point at which one end of the capacitor C7 and one end of the inductor L6 are connected is represented as a node 53. In addition, a current flowing through the node 52 via the resistor R5 and the inductor L5 is represented as I (r), and a current flowing through the node 53 via the resistor R6 and the inductor L6 is represented as I(r+dr). In addition, a voltage at the node 52 is represented as V(r), and a voltage at the node 53 is represented as V(r+dr). The value “r” is the distance from the node 51.

First, the processor 21 determines capacitance density σC, sheet resistance σR, and sheet inductance σL of the semiconductor device 50.

The capacitance density σC is the capacitance value of power supply wirings of the semiconductor device 50 per unit area. For example, the processor 21 obtains the capacitance density σC by dividing the capacitance value of the power supply wirings of the semiconductor device 50, which is previously extracted by a simulation or the like, by the chip area of the semiconductor device 50.

The sheet resistance σR is the sheet resistance of the power supply wirings of the semiconductor device 50. For example, the processor 21 obtains the sheet resistance σR by dividing the sheet resistance value of a wiring layer including power supply wirings by the proportion of the power supply wirings in the wiring layer. If the semiconductor device 50 has a plurality of wiring layers each of which includes power supply wirings, the processor 21 calculates the sheet resistance value of the power supply wirings for each of the wiring layers. The processor 21 obtains the sheet resistance σR by combining the calculated sheet resistance values in parallel.

The sheet inductance GL is defined by the sheet inductance of the power supply wirings of the semiconductor device 50. For example, the processor 21 obtains the sheet inductance GL by dividing the power supply wirings into squares, each side of which is approximately 100 μm long, and by calculating inductance (loop inductance) of a loop formed by each of the sides of the squares. The processor 21 uses a three-dimensional electromagnetic field analysis to obtain the sheet inductance σL.

The capacitance density σC, the sheet resistance σR, and the sheet inductance σL may also be obtained by using the design data 30, design rules, etc. of the semiconductor device 50.

By using the capacitance density σC, the sheet resistance σR, and the sheet inductance σL, the capacitance value dC of the capacitor C6, the resistance value dR of the resistor R6, and the inductance value dL of the inductor L6 in an area dr in FIG. 6 are represented by the following expressions (1) to (3), respectively.

$$\begin{matrix}dC = 2 π {rσ}_{C} \cdot dr & ( 1 ) \\ dR = {σ}_{R} \cdot \frac{dr}{2 π r} & ( 2 ) \\ d L = {σ}_{L} \cdot \frac{dr}{2 π r} & ( 3 )\end{matrix}$$

In addition, the voltage difference (V(r+dr)−V(r)) between the nodes 53 and 52 is obtained by the following expression (4).

$$V ( r + dr ) - V ( r ) = - d L \cdot \frac{\partial I ( r )}{\partial t} - dR \cdot I \\ \frac{\partial V ( r )}{\partial t} = - \frac{{σ}_{L}}{2 π r} \cdot \frac{\partial I ( r )}{\partial t} - \frac{{σ}_{R}}{2 π r} \cdot I \qquad ( 4 )$$

In addition, the following expression (5) is obtained by applying Kirchhoff's law to the node 52.

$$I ( r + dr ) - I ( r ) = dC \cdot \frac{\partial V ( r )}{\partial t} \\ \frac{\partial I ( r )}{\partial r} = 2 π r {σ}_{C} \cdot \frac{\partial V ( r )}{\partial t} \qquad ( 5 )$$

In addition, dr in the above expressions (4) and (5) is infinitesimal.

Next, boundary conditions are set as follows: a signal input to the center of the semiconductor device 50 is a sine-wave signal having an angular frequency ω (r=0, V=sin(ωt)) and the signal converges to 0 at an infinite distance from the semiconductor device 50 (r→∞, V→0). By solving expressions (4) and (5) with these boundary conditions, the following expression (6) is obtained.

$$V ( r , t ) = \frac{\pm \sqrt{α}}{2 π r {σ}_{C} i ω} {e}^{\pm \sqrt{α } r} {e}^{i ω t} \\ Where α = {ω}^{2} {σ}_{C} {σ}_{L} - i ω {σ}_{C} {σ}_{R} \qquad ( 6 )$$

Since the amplitude (voltage amplitude) of the sine-wave signal is set to 1 when r is 0 under the above boundary conditions, expression (6) indicates an attenuation rate of the amplitude. In addition, by using the frequency f of the sine-wave signal, the angular frequency ω of the sine-wave signal is given as ω=2πf.

For example, by using expression (6), the processor 21 calculates attenuation rates of the amplitude of the sine-wave signal having a frequency f at different distances r from the node 51. By changing the frequency f of the sine-wave signal, the processor 21 obtains attenuation characteristics (for example, the attenuation rate table 42 as illustrated in FIG. 6).

Next, an example in which the attenuation rate table 42 is created by measurement will be described.

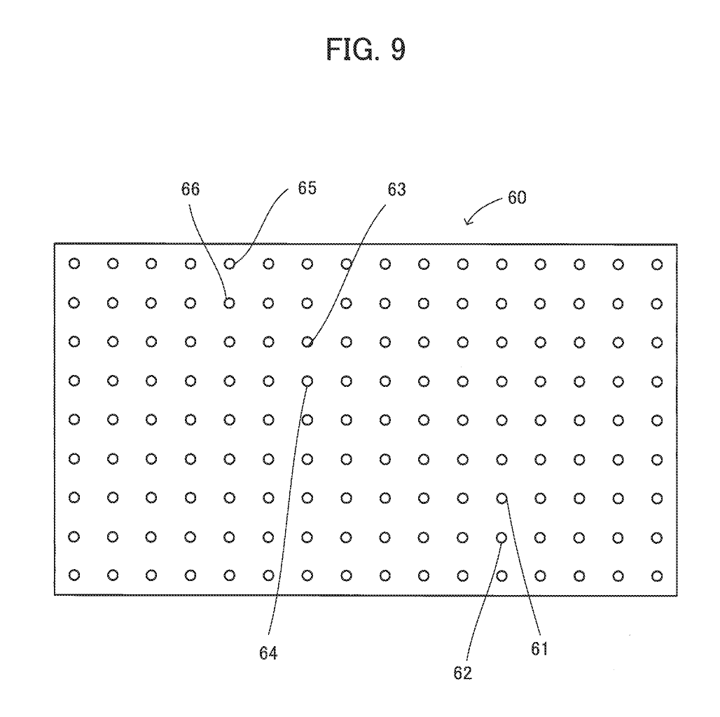

FIG. 9 illustrates an example in which the attenuation rate table is created by measurement.

FIG. 9 illustrates a part of a bump surface of a semiconductor device 60. FIG. 9 illustrates a plurality of bumps attached to power supply terminals and ground terminals. For example, bumps 61, 63, and 65 are attached to power supply terminals, and bumps 62, 64, and 66 are attached to ground terminals. The following description will be made assuming that the bumps 61 and 62 are located at the center of the bump surface of the semiconductor device 60.

For example, by using a voltage generator, a creator of the attenuation rate table 42 inputs a sine-wave signal to the bump 61 attached to a power supply terminal while changing the frequency of the signal. The bump 62 attached to a ground terminal serves as the ground. These applied signals propagate through the semiconductor device 60. By using a voltmeter, the creator of the attenuation rate table 42 measures the voltage amplitude of each propagating signal at a plurality of bumps each located at a different distance from the bumps 61 and 62 (for example, at the bumps 63 to 66). In this way, the creator obtains the attenuation characteristics of the signals. Namely, by actually measuring the attenuation characteristics in this way, the creator may create the attenuation rate table 42 as illustrated in FIG. 6.

When the attenuation rates are obtained by measurement, the measurement points and the frequencies are roughly set. Therefore, interpolation processing may be performed on the measured values. While linear interpolation may be performed, interpolation by using expression (6) improves the accuracy of the attenuation rates.

Next, comparisons will be made between attenuation rates obtained by measurement and attenuation rates obtained by calculation.

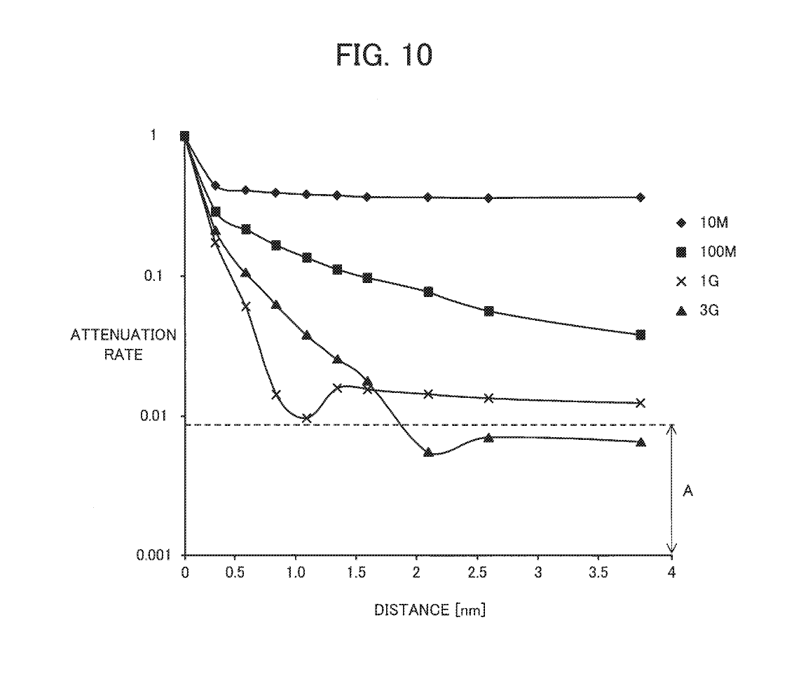

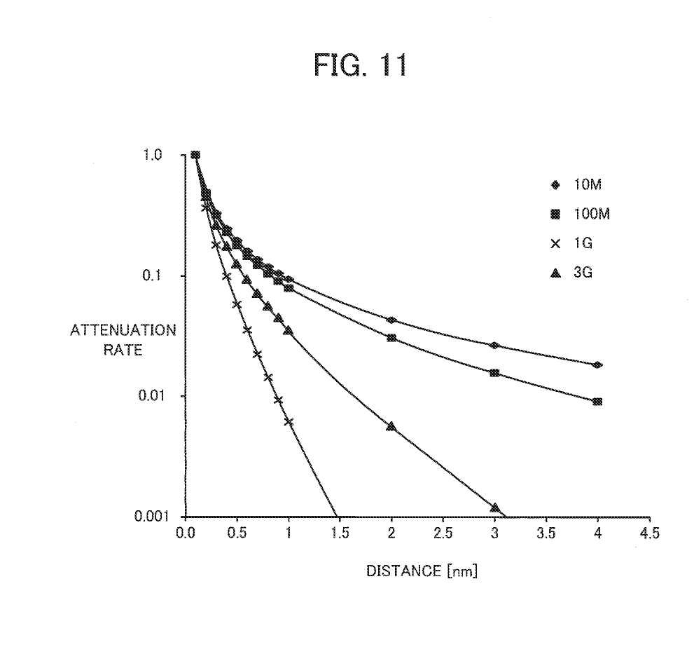

FIG. 10 illustrates an example of a set of attenuation rates obtained by measurement. FIG. 11 illustrates an example of a set of attenuation rates obtained by calculation.

In each of FIGS. 10 and 11, the horizontal axis indicates the distance from the center of a semiconductor device (namely, the pulse signal input point), and the vertical axis indicates the pulse signal, attenuation rate. FIGS. 10 and 11 illustrate the attenuation rates of a pulse signal whose frequency has been set to 10 MHz, 100 MHz, 1 GHz, and 3 GHz.

As to the pulse signals having frequencies of 10 MHz and 100 MHz, respectively, there is a relatively large difference between the measurement results and the calculation results. This is attributable to the infinite chip area used in the calculations. In contrast, as to the pulse signals having frequencies of 1 GHz and 3 GHz, respectively, the measurement results and the calculation results relatively match each other until the attenuation rates reach the measurement limit (a range indicated by an arrow A in FIG. 10) of the measurement apparatus.

Thus, when testing an impact of a high frequency pulse signal by using a CDM or the like, the test apparatus may perform calculation with expression (6) to obtain relatively accurate attenuation characteristics.

In addition, when testing an impact of a high frequency pulse signal by using a CDM or the like, the test apparatus may use the attenuation rates obtained by measurement and interpolate an area between measurement points and an area beyond the measurement limit with expression (6). In this way, the test apparatus obtains more accurate attenuation characteristics in a relatively large area.

Next, a method for creating the attenuation rate table that indicates attenuation characteristics will be described with reference to a flowchart.

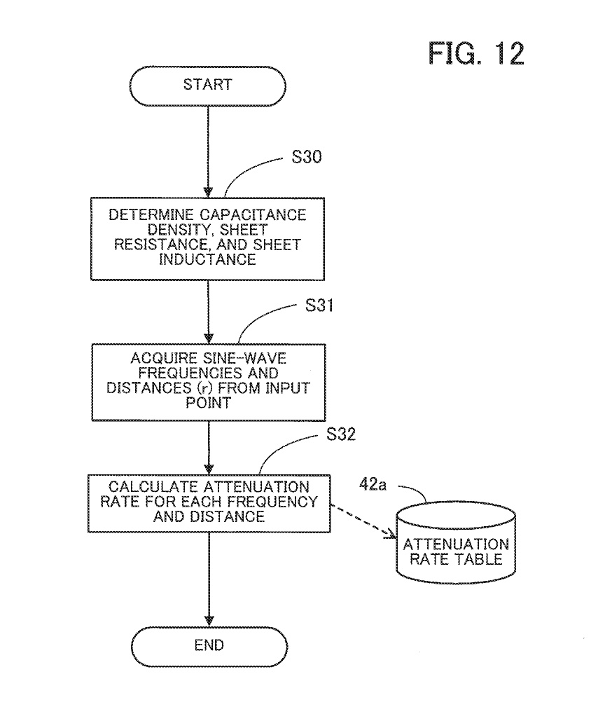

FIG. 12 is a flowchart illustrating an example of creating the attenuation rate table by calculation.

The following description will be made assuming that the computer 20 (the test apparatus) as illustrated in FIG. 3 creates an attenuation rate table.

Step S30: The processor 21 uses the above method so as to determine the capacitance density, the sheet resistance, and the sheet inductance of a semiconductor device.

Step S31: For example, the processor 21 acquires sine-wave frequencies input by a user (or previously stored in the HDD 23) and distances (r) from an input point.

Step S32: The processor 21 calculates an attenuation rate for each of the acquired frequencies and distances by using expression (6) based on the capacitance density, the sheet resistance, and the sheet inductance. In this way, an attenuation rate table 42a is created. The processor 21 stores the created attenuation rate table 42a in the HDD 23, for example.

The processor 21 may perform the above steps S30 and S31 in reverse order.

Next, processing for interpolating measured values by using expression (6) ill be described with reference to a flowchart.

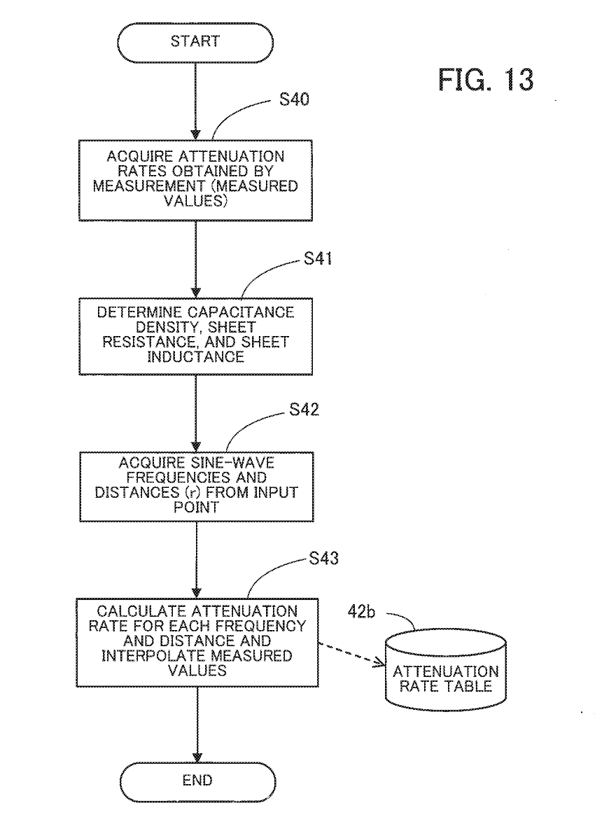

FIG. 13 is a flowchart illustrating an example of creating the attenuation rate table by performing interpolation processing on measured values.

The following description will be made assuming that the computer 20 (the test apparatus) illustrated in FIG. 3 creates an attenuation rate table.

Step S40: The processor 21 acquires attenuation rates (hereinafter, referred to as measured values) obtained by measurement. For example, the attenuation rates are previously stored in the HDD 23.

Step S41: The processor 21 uses the above method so as to determine the capacitance density, the sheet resistance, and the sheet inductance of a semiconductor device.

Step S42: For example, the processor 21 acquires sine-wave frequencies input by a user (or previously stored in the HDD 23) and distances (r) from an input point.

Step S43: The processor 21 calculates an attenuation rate for each of the acquired frequencies and distances by using expression (6) based on the capacitance density, the sheet resistance, and the sheet inductance. By interpolating measured values with these attenuation rates, the processor 21 creates an attenuation rate table 42b. The processor 21 stores the created attenuation rate table 42b in the HDD 23, for example.

The processor 21 may perform the above steps S40 to S42 in a different order, as appropriate.

While, based on to the above embodiments, one aspect of each of the test method, the test apparatus, and the program has been described, the above description indicates merely examples. Thus, the above description shall not be construed as limitations.

According to the test method, the test apparatus, and the program discussed herein, the amount of calculation performed in testing is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A test method for testing an impact of electrostatic discharge on a semiconductor device, the method comprising:
determining, by a processor, a first area in a circuit area of the semiconductor device indicated by design data, based on attenuation characteristics of a pulse signal caused by the electrostatic discharge, the attenuation characteristics of the pulse signal being dependent on a frequency of the pulse signal and a distance from an input point of the pulse signal;
extracting, by the processor, a resistor, a capacitor, or an inductor, or any combination thereof from the determined first area; and
creating, by the processor, an equivalent circuit of the semiconductor device within the first area, based on a result of the extracting.

2. The test method according to claim 1, further comprising:
extracting, by the processor, the resistor, the capacitor, or the inductor, or any combination thereof from the first area based on a first distance from the input point, the first distance being corresponding to a point at which a current or voltage value of the pulse signal is less than or equal to an allowable current or voltage value of the semiconductor device.

3. The test method according to claim 1, further comprising:
obtaining, by the processor, the attenuation characteristics by calculating change of attenuation rates of amplitude of a sine-wave signal input to a first input point of a circuit model, the circuit model being based on capacitance density, sheet resistance, and sheet inductance of the semiconductor device, the change being caused by change of a distance from the first input point when the frequency of the sine-wave signal is changed.

4. The test method according to claim 1, further comprising:
obtaining, by the processor, the attenuation characteristics by inputting a sine-wave signal to a first terminal of the semiconductor device while changing a frequency of the sine-wave signal and by measuring amplitude of the sine-wave signal at a plurality of second terminals, each of the plurality of second terminals being located at a different distance from the first terminal.

5. The test method according to claim 1, further comprising:
obtaining, by the processor, the attenuation characteristics by interpolating first attenuation rates with first values,
wherein the first attenuation rates are obtained by inputting a sine-wave signal to a first terminal of the semiconductor device while changing a frequency of the sine-wave signal and measuring amplitude of the sine-wave signal at a plurality of second terminals, each of the plurality of second terminals being located at a different distance from the first terminal, and
the first values are obtained by calculating second attenuation rates of the sine-wave signal input to a first input point of a circuit model that corresponds to the first terminal with the frequency of the pulse signal and a distance from the first input point being changed, the circuit model being based on capacitance density, sheet resistance, and sheet inductance of the semiconductor device.

6. The test method according to claim 1,
wherein the pulse signal is a signal caused by the electrostatic discharge, based on a charged device model.

7. The test method according to claim 1, further comprising:
performing, by the processor, a circuit simulation in which the pulse signal is input, based on the equivalent circuit; and
determining, by the processor, based on current or voltage information included in a result from the circuit simulation, whether a current or voltage exceeding an allowable current or voltage of the semiconductor device occurs.

8. A test apparatus for testing an impact of electrostatic discharge on a semiconductor device, the test apparatus comprising:
a processor configured to perform a procedure including:
determining a first area in a circuit area of the semiconductor device indicated by design data, based on attenuation characteristics of a pulse signal caused by the electrostatic discharge, the attenuation characteristics of the pulse signal being dependent on a frequency of the pulse signal and a distance from an input point of the pulse signal;
extracting a resistor, a capacitor, or an inductor, or any combination thereof from the determined first area; and
creating an equivalent circuit of the semiconductor device within the first area, based on a result of the extracting.

9. The test apparatus according to claim 8, wherein the procedure further includes:
extracting the resistor, the capacitor, or the inductor, or any combination thereof from the first area based on a first distance from the input point, the first distance being corresponding to a point at which a current or voltage value of the pulse signal is less than or equal to an allowable current or voltage value of the semiconductor device.

10. The test apparatus according to claim 8, wherein the procedure further includes:
obtaining the attenuation characteristics by calculating change of attenuation rates of amplitude of a sine-wave signal input to a first input point of a circuit model, the circuit model being based on capacitance density, sheet resistance, and sheet inductance of the semiconductor device, the change being caused by change of a distance from the first input point when the frequency of the sine-wave signal is changed.

11. The test apparatus according to claim 8, wherein the procedure further includes:
obtaining the attenuation characteristics by inputting a sine-wave signal to a first terminal of the semiconductor device while changing a frequency of the sine-wave signal and by measuring amplitude of the sine-wave signal at a plurality of second terminals, each of the plurality of second terminals being located at a different distance from the first terminal.

12. The test apparatus according to claim 8, wherein:
the procedure further includes obtaining the attenuation characteristics by interpolating first attenuation rates with first values,
the first attenuation rates are obtained by inputting a sine-wave signal to a first terminal of the semiconductor device while changing a frequency of the sine-wave signal and measuring amplitude of the sine-wave signal at a plurality of second terminals, each of the plurality of second terminals being located at a different distance from the first terminal, and
the first values are obtained by calculating second attenuation rates of the sine-wave signal input to a first input point of a circuit model that corresponds to the first terminal with the frequency of the pulse signal and a distance from the first input point being changed, the circuit model being based on capacitance density, sheet resistance, and sheet inductance of the semiconductor device.

13. The test apparatus according to claim 8, wherein the procedure further includes:
performing a circuit simulation in which the pulse signal is input, based on the equivalent circuit; and
determining, based on current or voltage information included in a result from the circuit simulation, whether a current or voltage exceeding an allowable current or voltage of the semiconductor device occurs.

14. A non-transitory computer-readable recording medium storing a computer program that causes a computer to perform a procedure for testing an impact of electrostatic discharge on a semiconductor device, the procedure comprising:
determining a first area in a circuit area of the semiconductor device indicated by design data, based on attenuation characteristics of a pulse signal caused by the electrostatic discharge, the attenuation characteristics of the pulse signal being dependent on a frequency of the pulse signal and a distance from an input point of the pulse signal;
extracting a resistor, a capacitor, or an inductor, or any combination thereof from the determined first area; and
creating an equivalent circuit of the semiconductor device within the first area, based on a result of the extracting.

15. The non-transitory computer-readable recording medium according to claim 14, wherein the procedure further includes:
extracting the resistor, the capacitor, or the inductor, or any combination thereof from the first area based on a first distance from the input point, the first distance being corresponding to a point at which a current or voltage value of the pulse signal is less than or equal to an allowable current or voltage value of the semiconductor device.

16. The non-transitory computer-readable recording medium according to claim 14, wherein the procedure further includes:
obtaining the attenuation characteristics by calculating change of attenuation rates of amplitude of a sine-wave signal input to a first input point of a circuit model, the circuit model being based on capacitance density, sheet resistance, and sheet inductance of the semiconductor device, the change being caused by change of a distance from the first input point when the frequency of the sine-wave signal is changed.

17. The non-transitory computer-readable recording medium according to claim 14, wherein the procedure further includes:
obtaining the attenuation characteristics by inputting a sine-wave signal to a first terminal of the semiconductor device while changing a frequency of the sine-wave signal and by measuring amplitude of the sine-wave signal at a plurality of second terminals, each of the plurality of second terminals being located at a different distance from the first terminal.

18. The non-transitory computer-readable recording medium according to claim 14, wherein:
the procedure further includes obtaining the attenuation characteristics by interpolating first attenuation rates with first values,
the first attenuation rates are obtained by inputting a sine-wave signal to a first terminal of the semiconductor device while changing a frequency of the sine-wave signal and measuring amplitude of the sine-wave signal at a plurality of second terminals, each of the plurality of second terminals being located at a different distance from the first terminal, and
the first values are obtained by calculating second attenuation rates of the sine-wave signal input to a first input point of a circuit model that corresponds to the first terminal with the frequency of the pulse signal and a distance from the first input point being changed, the circuit model being based on capacitance density, sheet resistance, and sheet inductance of the semiconductor device.

19. The non-transitory computer-readable recording medium according to claim 14, wherein the procedure further includes:
performing a circuit simulation in which the pulse signal is input, based on the equivalent circuit; and
determining, based on current or voltage information included in a result from the circuit simulation, whether a current or voltage exceeding an allowable current or voltage of the semiconductor device occurs.
